(19) United States
(12) Patent Application Publication
(10) Pub. No.: US 2007/0274699 A1
(43) Pub. Date: Nov. 29, 2007

(54) LENS MODULE

(75) Inventors: Fu-Ming Chuang, Hsinchu (TW); Chih-Meng Wu, Hsinchu (TW); Ping-Kun Shih, Hsinchu (TW); Shang-Jern Shih, Hsinchu (TW); Tung-Hua Chou, Hsinchu (TW)

Correspondence Address: J C PATENTS, INC., 4 VENTURE, SUITE 250, IRVINE, CA, 92618, US

(73) Assignee: YOUNG OPTICS INC., Hsinchu (TW)

(21) Appl. No.: 11/735,866

(22) Filed: Apr. 16, 2007

(30) Foreign Application Priority Data
May 29, 2006 (TW) 95118962

(51) Int. Cl. G03B 13/34

(52) U.S. Cl. 396/133

(57) ABSTRACT

A lens module including a guide set, a lens set, a magnet and an electromagnetic winding set is provided. The lens set is movably disposed on the guide set, and the magnet is disposed on the lens set. The electromagnetic winding set is disposed at the side of the lens set and adjacent to the magnet. The electromagnetic winding set and the magnet are suitable for generating an electromagnetic force for controlling the movement of the magnet. By the movement of the magnet, the lens set is driven to move along the guide set.

### CROSS-REFERENCE TO RELATED APPLICATION

This application claims the priority benefit of Taiwan application serial no. 95118962, filed May 29, 2006. All disclosure of the Taiwan application is incorporated herein by reference.

### BACKGROUND OF THE INVENTION

1. Field of the Invention

The present invention relates to a lens module, and more particularly, to an auto-focusing lens module.

2. Description of Related Art

FIG. 1 is a side view of a conventional manual-focusing lens module. As shown in FIG. 1, a lens 110 of the conventional lens module 10 passes into an inner ring 120. Furthermore, the inner ring 120 is leaned against and between the focus-adjusting ring 130 and the spring 140. Because the focus-adjusting ring 130 has segmented steps, the inner ring 120 and the lens 110 are driven to move up and down along the Y-axis when the focus-adjusting ring 130 is manually turned to complete a focusing operation. However, because the lens module 10 needs to be manually focused, its operation is very inconvenient.

FIG. 2 is a side view of another conventional lens module focused via a stepping motor. As shown in FIG. 2, a lens 110 of the lens module 20 passes into the inner ring 120. Similarly, the inner ring 120 is leaned against and between the focus-adjusting ring 130′ and the spring 140. The method of focusing the lens module 20 includes electrically controlling the stepping motor 150 to drive a transmission mechanism (for example, screw, turbine, gear wheel or the focus-adjusting ring 130′). Through the stepping motor 150, the inner ring 120 and the lens 110 are driven up and down along the Y-axis to complete a focusing operation. Although the lens module 20 is automatically focused, the lens module 20 is more bulky and the stepping motor 150 and the transmission mechanism are more expensive. Moreover, more power is wasted while performing the focusing process.

FIGS. 3A and 3B show another two types of conventional lens modules, each having a voice coil motor for performing the focusing process. First, as shown in FIG. 3A, a lens 110 of the lens module 30 passes into the magnetizable inner ring 160. Magnets 170 are disposed on each side of the magnetizable inner ring 160. Through the electromagnetic force between the magnets 170 and the magnetizable inner ring 160, the magnetizable inner ring 160 is prevented from moving to the left or the right so that the lens 10 is fixed on the X-axis. To adjust the focus of the lens module 30, the magnitude of current passing into the winding 180 is controlled to generate different amount of magnetic levitation. Therefore, the magnetizable inner ring 160 and the lens 110 are driven to move up and down along the Y-axis to complete a focusing operation.

However, the focusing speed of the foregoing lens module 30 is slow. Moreover, after performing the focusing process, a continuous current must be provided to the winding 180 to prevent the spring force g of the spring 140 from moving the magnetizable inner ring 160 down so that the position of the lens 110 is maintained. Therefore, the conventional lens module 30 consumes considerable power. In addition, using electromagnetic force to fix the position of the lens 110 on the X-axis often leads to tilting of the lens. Moreover, the lens module 30 has less capacity for withstanding vibration or surviving a drop test.

As shown in FIG. 3B, a lens 110 in the lens module 40 passes into the magnetizable inner ring 160′ and is prevented from moving to the left or the right through a set of guide rods 185 so that the lens 110 is fixed on the X-axis. In addition, a sensor 190 detects the position of the magnetizable inner ring 160 on the Y-axis and feeds back signal to an application specific integrated circuit (ASIC) 195. The ASIC 195 drives the winding 10 according to the location of the magnetizable inner ring 160′ so that the magnetizable inner ring 160′ and the lens 110 are moved to a desire location to complete a focusing operation. It should be noted that although there is no need to supply a current to the winding 180 after the focusing operation is completed, the production cost of the lens module 40 is high.

FIG. 4 is a side view of a conventional lens module with a two-step electrical focusing operation. As shown in FIG. 4, a lens 110 which is in the lens module 50 passes into the inner ring 120′. Furthermore, a circular magnet 196 is disposed outside the inner ring 120′. The method of focusing the lens module 50 includes changing the direction of the current flowing into the winding 180. As a result, an attractive force or a repulsive force is created between the winding 180 and the circular magnet 196 to drive the circular magnet 196, the inner ring 120′ and the lens 110 along the Y-axis to the topmost end or the bottommost end. In addition, the magnetizable metal plate 197 is partially magnetized. Thus, when the current flowing into the winding 180 is stopped after the focusing operation, if the lens module 110 moves to the topmost end, an attractive force between the topmost magnetizable metal plate 197 is formed which holds the lens 110 at the topmost end. Similarly, if the lens module 110 moves to the bottommost end, an attractive force between the bottommost magnetizable metal plate 197 and the circular magnet 196 is formed which holds the lens 110 at the bottommost end.

The foregoing lens module 50 only allows a two-step focus change and is rather bulky. In addition, the cost of the circular magnet 196 is high so that the cost of producing the lens module 50 is increased.

### SUMMARY OF THE INVENTION

Accordingly, at least one objective of the present invention is to provide a lens module having a multi-step focusing mechanism that has a lower production cost and occupies a smaller volume.

Other objectives, features and advantages of the present invention will be further understood from the further technology features disclosed by the present invention wherein there are shown and described preferred embodiments of this invention, simply by way of illustration of modes best suited to carry out the invention.

To achieve the above-mentioned or other objectives and in accordance with the purpose of the invention, as embodied and broadly described herein, one of the embodiments of the present invention provides a lens module. The lens module includes a guide set, a lens set, a magnet and an electromagnetic winding set. The lens set is movably disposed on the guide set, and the magnet is disposed on the lens set. The electromagnetic winding set is disposed at the side of the lens set and adjacent to the magnet. The electromagnetic winding set and the magnet are suitable for generating an electromagnetic force for controlling the movement of the magnet. By the movement of the magnet, the lens set is driven to move along the guide set.

The two magnetic poles of the foregoing magnet are connected to the lens module.

The foregoing electromagnetic winding set further includes a first electromagnetic winding and a second electromagnetic winding. The first electromagnetic winding is disposed at one end of the guide set and the magnet is located on the direction of extension of the first electromagnetic winding. The second electromagnetic winding is disposed between the two ends of the guide set and the direction of extension of the second electromagnetic winding is different from that of the first electromagnetic winding.

The direction of extension of the foregoing second electromagnetic winding is substantially perpendicular to that of the first electromagnetic winding.

Each of the foregoing first electromagnetic winding and the second electromagnetic winding includes a ferromagnetic plate and a winding wrapping around the ferromagnetic plate.

The foregoing electromagnetic winding set includes two windings and a ferromagnetic plate. The ferromagnetic plate further includes a linear body and three branches connected to the linear body. The two windings wrap around the linear body. The three branches extend respectively from the two ends of the linear body and the central area between the two windings on the linear body toward the lens module.

The present invention also provides an alternative lens module. The lens module includes a guide set, a lens set, a plurality of magnet sets and a plurality electromagnetic winding sets. The lens set is movably disposed on the guide set, and the magnet sets are disposed on the lens set. The electromagnetic winding sets are disposed at the side of the lens set and adjacent to one of the magnet sets. The electromagnetic winding sets and the magnet sets are suitable for generating electromagnetic forces for controlling the movement of the magnet sets. By the movement of the magnet sets, the lens set is driven to move along the guide set.

In the foregoing lens module, each magnet set includes two connected magnets. Furthermore, the magnetic poles at the junction between the two magnets are identical.

In the foregoing lens module, each electromagnetic winding set includes two windings and a ferromagnetic plate. The ferromagnetic plate includes a linear body and three branches connected to the linear body. The two windings wrap around the linear body. The three branches extend respectively from the two ends of the linear body and between the two windings on the linear body toward the lens module.

The foregoing lens module further includes a base connected to the lens module. The magnetic sets are disposed on the base so that the magnet sets are connected to the lens module through the base.

In the two foregoing types of lens modules, the branches are substantially perpendicular to the linear body.

In the two foregoing types of lens module, the ferromagnetic plate is a silicon steel plate, for example.

In the two foregoing types of lens module, the guide set includes a first guide and a second guide substantially parallel to the first guide. Furthermore, the lens module is disposed on the first guide and the second guide.

In the present invention, the direction of the current flowing into the electromagnetic winding is controlled to produce an electromagnetic force between the electromagnetic winding and the magnet so that the lens module is driven to a desired location. Because the lens module of the present invention has a simple structure, it is less bulky and the production cost is lower. In addition, by controlling the direction and magnitude of current in the electromagnetic winding, the lens module can have a multi-step focusing function.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a side view of a conventional manual-focus lens module.

FIG. 2 is a side view of another conventional lens module driven by a stepping motor.

FIGS. 3A and 3B show another two types of conventional lens modules, each having a voice coil motor for performing the focusing process.

FIG. 4 is a side view of a conventional lens module with a two-step electrical focusing operation.

FIGS. 5A to 5C are diagrams showing a lens module at different magnifications according to a first embodiment of the present invention.

FIGS. 6A to 6C are diagrams showing a lens module at different magnifications according to a second embodiment of the present invention.

FIGS. 7A to 7C are diagrams showing a lens module at different magnifications according to a third embodiment of the present invention.

FIG. 8 is a diagram showing a lens of the lens module moving from a topmost end of a guide set to a middle location according to the third embodiment of the present invention.

FIG. 9 is a diagram showing the lens of the lens module stationed in a middle location according to the third embodiment of the present invention.

FIG. 10 is a diagram showing the lens of the lens module moving from a bottommost end of the guide set to a middle location according to the third embodiment of the present invention.

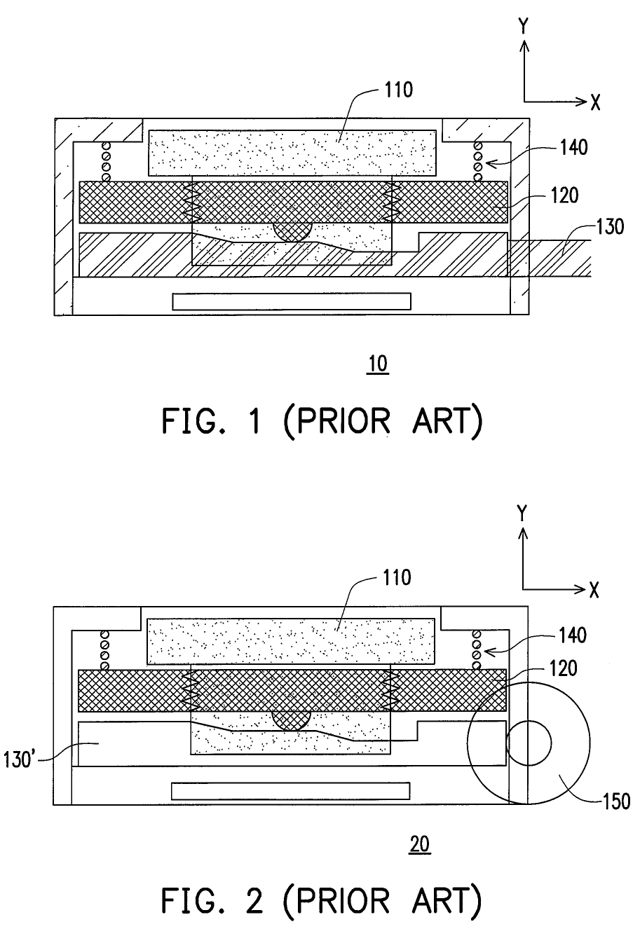

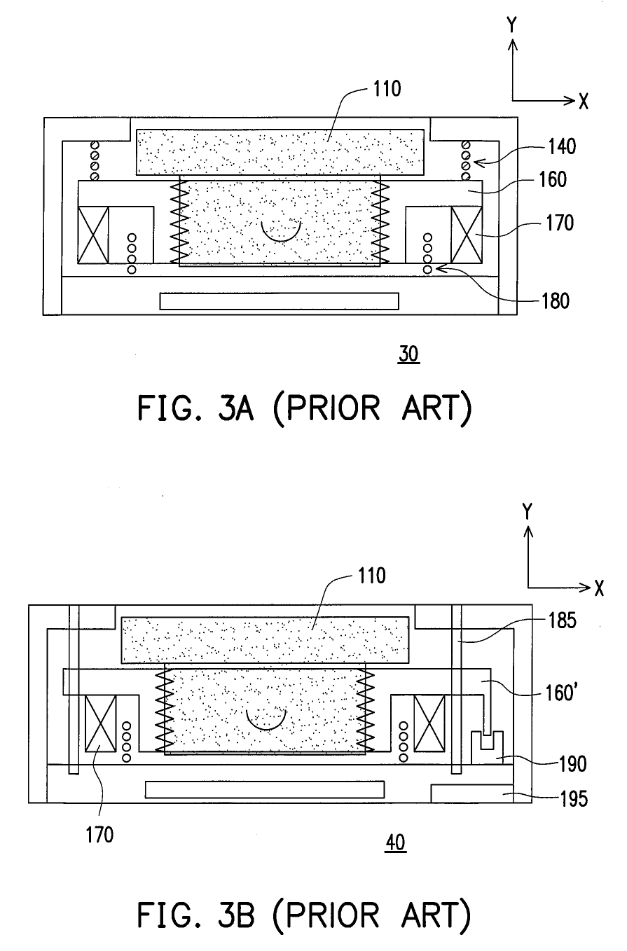

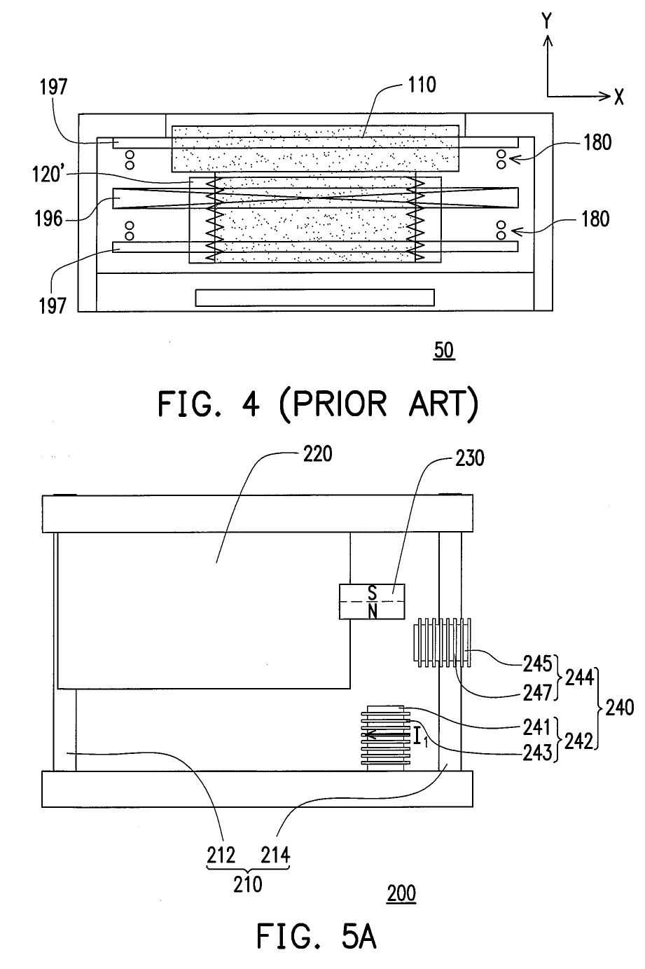

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive. Reference will now be made in detail to the present preferred embodiments of the invention, examples of which are illustrated in the accompanying drawings. Wherever possible, the same reference numbers are used in the drawings and the description to refer to the same or like parts.

### First Embodiment

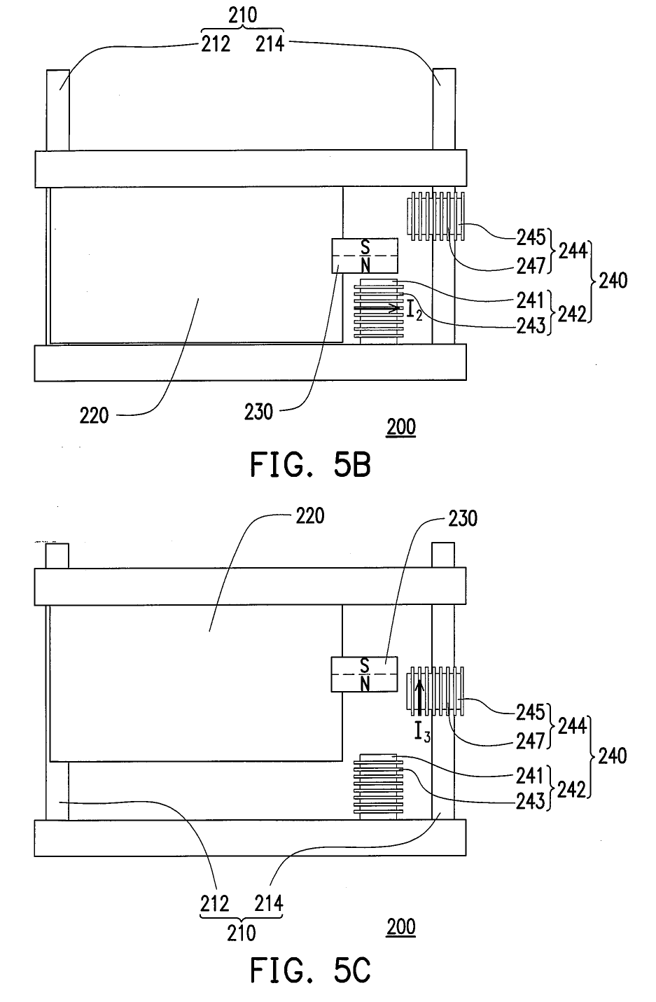

FIGS. 5A to 5C are diagrams showing a lens module at different magnifications according to a first embodiment of the present invention. As shown in FIGS. 5A to 5C, the lens module 200 in the present embodiment includes a guide set 210, a lens set 220, a magnet 230 and an electromagnetic winding set 240. The lens set 220 is movably disposed on the guide set 210, and the magnet 230 is disposed on the lens set 220. The electromagnetic winding set 240 is disposed at one side of the lens set 220 and adjacent to the magnet 230. The electromagnetic winding set 240 and the magnet 230 are suitable for generating an electromagnetic force to control the movement of the magnet 230. Through the movement of the magnet 230, the lens set 220 is driven to move along the guide set 210.

In the foregoing lens module 200, the two magnetic poles (the N-pole and the S-pole) are connected to the lens set 220 such that the N-pole is below the S-pole, for example. The guide set 210 includes a first guide 212 and a second guide 214 substantially parallel to the first guide 212, and the lens set 220 is disposed on the first guide 212 and the second guide 214. Furthermore, the electromagnetic winding set 240 includes a first electromagnetic winding 242 and a second electromagnetic winding 244. The first electromagnetic winding 242 is disposed at one end of the guide set 210 (for example, the lower end of the guide set 210) and the magnet 230 is located on the direction of extension of the first electromagnetic winding 242. The second electromagnetic winding 244 is disposed between the two ends of the guide set 210, and the direction of extension of the second electromagnetic winding 244 is different from that of the first electromagnetic winding 242. In one preferred embodiment, the direction of extension of the second electromagnetic winding 244 is substantially perpendicular to that of the first electromagnetic winding 242.

The first electromagnetic winding 242 further includes a ferromagnetic plate 241 and a winding 243 that wraps around the ferromagnetic plate 241. Similarly, the second electromagnetic winding 244 further includes a ferromagnetic plate 245 and a winding 247 that wraps around the ferromagnetic material plate 245. The ferromagnetic plates 241 and 245 are fabricated using silicon steel, for example. In addition, the positions of the first electromagnetic winding 242 and the second electromagnetic winding 244 are fixed.

As shown in FIG. 5A, when the lens set 220 needs to be moved to the topmost end of the guide set 210, a current I₁ is passed to the winding 243 so that the first electromagnetic winding 242 is turned into an electromagnet with an N-pole on top and an S-pole below. The repulsive force between the N-pole of the electromagnet and the N-pole of the magnet 230 pushes the magnet 230 up. Furthermore, as the magnet 230 moves up, the lens set 220 is also driven to move up by the guide set 210 until the topmost end of the guide set 210 is reached.

As shown in FIG. 5B, when the lens set 220 needs to be moved to the bottommost end of the guide set 210, a current I₂ with a direction opposite to the current I₁ is passed into the winding 243 so that the first electromagnetic winding 242 is turned to an electromagnet with an S-pole on top and an N-pole below. The attractive force between the S-pole of the electromagnet and the N-pole of the magnet 230 pulls the magnet 230 down. Furthermore, as the magnet 230 moves down, the lens set 220 is also driven to move down by the guide set 210 until the bottommost end of the guide set 210 is reached.

As shown in FIG. 5C, when the lens set 220 needs to be moved to the middle of the guide set 220, a current is passed to the winding 243 so that the lens 220 is moved to the middle of the guide set 210. As the lens set 220 moves to the desired location, the current to the winding 243 is stopped and another current is passed to the winding 247 so that the lens set 220 is stationed in the desired location through the second electromagnetic winding 244. More specifically, if the lens set 220 is located at the topmost end of the guide set 210, a current I₂ is passed to the winding 243 so that an attractive force between the first electromagnetic winding 242 and the magnet 230 is formed which makes the lens set 220 move down. On the contrary, if the lens set 220 is located at the bottommost end of the guide set 210, a current I₁ is passed to the winding 243 so that a repulsive force between the first electromagnetic winding 242 and the magnet 230 is formed which makes the lens set 220 move up. When the lens set 220 moves to one side of the second electromagnetic winding 244, the current to the winding 243 is stopped. Then, another current I₃ is passed to the winding 247 so that the second electromagnetic winding 244 is turned into an electromagnet with an S-pole on the left and an N-pole on the right. Through the attraction between the S-pole of the electromagnet and the N-pole of the magnet 230, the lens set 220 is fixed in position.

It should be noted that a current with a direction opposite to that of the current I₃ might be passed to the winding 247 in the present embodiment so that the second electromagnetic winding 244 is turned into an electromagnet with an N-pole on the left and an S-pole on the right. Through the attraction between the N-pole of the electromagnet and the S-pole of the magnet 230, the position of the lens set 220 is fixed. Thus, the stationing points of the lens set 220 are increased. In addition, the magnetic circuit efficiency of the lens module 200 in the present embodiment is high and the starting current is small. Furthermore, because the lens module in the present embodiment has a simple structure, it is less bulky and has a lower production cost. Although the N-pole of the magnet 230 in the present embodiment is located under the S-pole, anyone familiar with the technology may notice that it equally works when the N-pole of the magnet 230 is above the S-pole.

### Second Embodiment

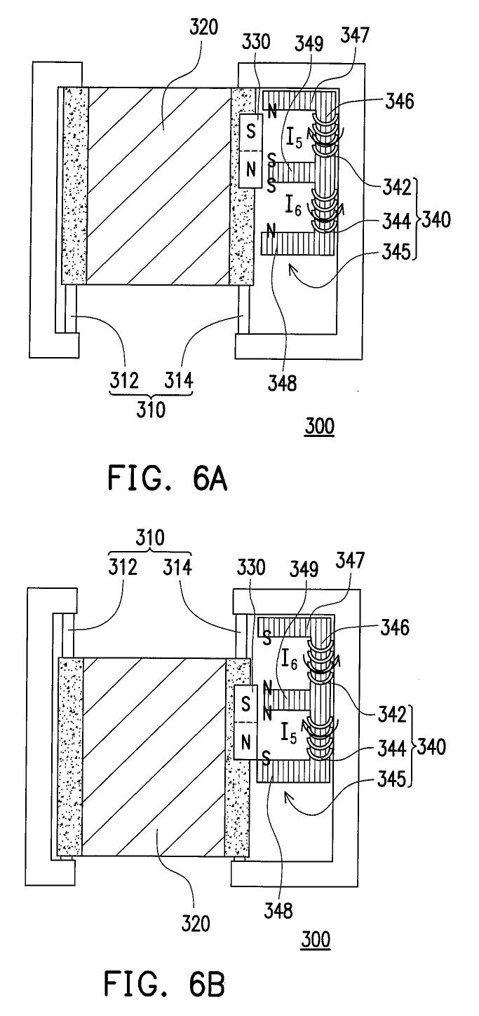

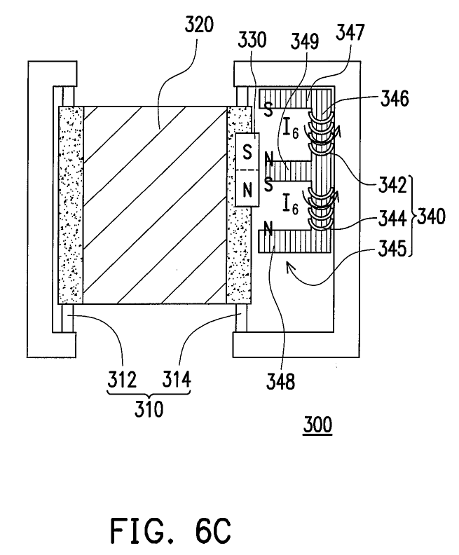

FIGS. 6A to 6C are diagrams showing a lens module at different magnifications according to a second embodiment of the present invention. As shown in FIGS. 6A to 6C, the lens module 300 in the present embodiment includes a guide set 310, a lens set 320, a magnet 330 and an electromagnetic winding 340. The lens set 320 is movably disposed on the guide set 310, and the magnet 330 is disposed on the lens set 320. The electromagnetic winding 340 is disposed on one side of the lens set 320 and adjacent to the magnet 330. The electromagnetic winding 340 includes two windings 342 and 344 and a ferromagnetic plate 345. The ferromagnetic plate 345 is fabricated using silicon steel, for example. The ferromagnetic plate 345 includes a linear body 346 and three branches 347, 348, 349 all connected to the linear body 346. The windings 342 and 344 wrap around the linear body 346. Furthermore, the branches 347, 348, 349 are respectively connected to the two ends of the linear body 346 and between the two windings 342 and 344 on the linear body 346 and extend in a direction toward the lens set 320. In one preferred embodiment of the present embodiment, the branches 347, 348, 349 are disposed in a direction substantially perpendicular to the linear body 346.

In the foregoing lens module 300, the two magnetic poles (the N-pole and the S-pole) of the magnet 330 are connected to the lens set 320 such that the N-pole is, for example, under the S-pole. The guide set 310 includes a first guide 312 and a second guide 314 substantially in parallel to the first guide 312. Furthermore, the lens set 320 is disposed on the first guide 312 and the second guide 314.

In the present embodiment, the electromagnetic winding 340 is suitable for generating an electromagnetic force on the magnet 300 to control the movement of the magnet 330. Through the movement of the magnet 330, the lens set 320 is driven to move along the guide set 310. In the following, the movement of the lens set 320 is explained in more detail.

As shown in FIG. 6A, when the lens set 320 needs to be moved to the topmost end of the guide set 310, a current I₅ is passed to the winding 342 and a current I₆ with a direction opposite to that of the current I₅ is passed to the winding 344 so that the branches 347, 348 are magnetized into N-poles while the upper half and the lower half of the branch 349 are magnetized into S-poles. Thus, the attractive force between the branch 347 and the S-pole of the magnet 330 and the repulsive force between the branch 348 and the N-pole of the magnet 330 push the magnet 330 up and move the lens set 320 along the guide set 310 to the topmost end of the guide set 310. When the lens set 320 has reached the topmost end of the guide set 310, the supply of current to the windings 342 and 344 is stopped. After stopping the supply of current to the windings 342 and 344, the magnetic property of the magnetized branches 347, 348 and 349 doesn't instantly disappear so that the position of the lens set 320 is fixed.

As shown in FIG. 6B, when the lens set 320 needs to be moved to the bottommost end of the guide set 310, a current I₅ is passed to the winding 344 and a current I₆ with a direction opposite to that of the current I₅ is passed to the winding 342 so that the branches 347, 348 are magnetized into S-poles while the upper half and the lower half of the branch 349 are magnetized into N-poles. Thus, the repulsive force between the branch 347 and the S-pole of the magnet 330 and the attractive force between the branch 348 and the N-pole of the magnet 330 push the magnet 330 down and move the lens set 320 along the guide set 310 to the bottommost end of the guide set 310. Similarly, when the lens set 320 has reached the bottommost end of the guide set 310, the supply of current to the windings 342 and 344 is stopped.

As shown in FIG. 6C, when the lens set 320 needs to be moved to the middle of the guide set 320, a current I₆ is passed to the winding 342 and the winding 344 so that the lower half of the branches 347 and 349 are magnetized into S-poles and the upper half of the branches 348 and 349 are magnetized into N-poles. Thus, the repulsive force between the branch 347 and the S-pole of the magnet 330 and the repulsive force between the branch 348 and the N-pole of the magnet 330 push the magnet 330 to the middle of the ferromagnetic plate 345 and move the lens set 320 along the guide set 310 to the middle of the guide set 310. Similarly, when the lens set 320 has reached the middle of the guide set 310, the supply of current to the windings 342 and 344 is stopped.

The lens module 300 in the present embodiment has a high magnetic circuit efficiency and a small starting current. Furthermore, because the lens module 300 has a simple structure, it is less bulky and has a lower production cost. In addition, stopping the supply of current to the windings 342 and 344 after the focusing operation saves a lot of power. Although the N-pole of the magnet 330 in the present embodiment is located under the S-pole, anyone familiar with the technology may notice that it equally works when the N-pole of the magnet 330 is above the S-pole.

It should be noted that, beside controlling the direction of currents in the windings 342 and 344 to move the lens module 320, the magnitude of the currents flowing inside the windings 342 and 344 could be adjusted to increase the point positioning of the lens set 320. For example, in FIG. 6C, when the magnitude of the current flowing to the winding 342 is greater than that of the current flowing to the winding 344, the magnetic property of the branch 347 is stronger than that of the branch 345. Therefore, the repulsive force between the branch 347 and the S-pole of the magnet 330 is greater than the repulsive force between the branch 348 and the N-pole of the magnet 330. As a result, the lens set 320 moves down along with the magnet 330 until the repulsive force between the branch 347 and the S-pole of the magnet 330 equals the repulsive force between the branch 348 and the N-pole of the magnet 330. Conversely, when the current passing to the winding 342 is lower than the current passes to the winding 344, the magnetic property of the branch 347 is weaker than that of the branch 345. Therefore, the repulsive force between the branch 347 and the S-pole of the magnet 330 is smaller than the repulsive force between the branch 348 and the N-pole of the magnet 330. As a result, the lens set 320 moves up along with the magnet 330 until the repulsive force between the branch 347 and the S-pole of the magnet 330 equals the repulsive force between the branch 348 and the N-pole of the magnet 330.

### Third Embodiment

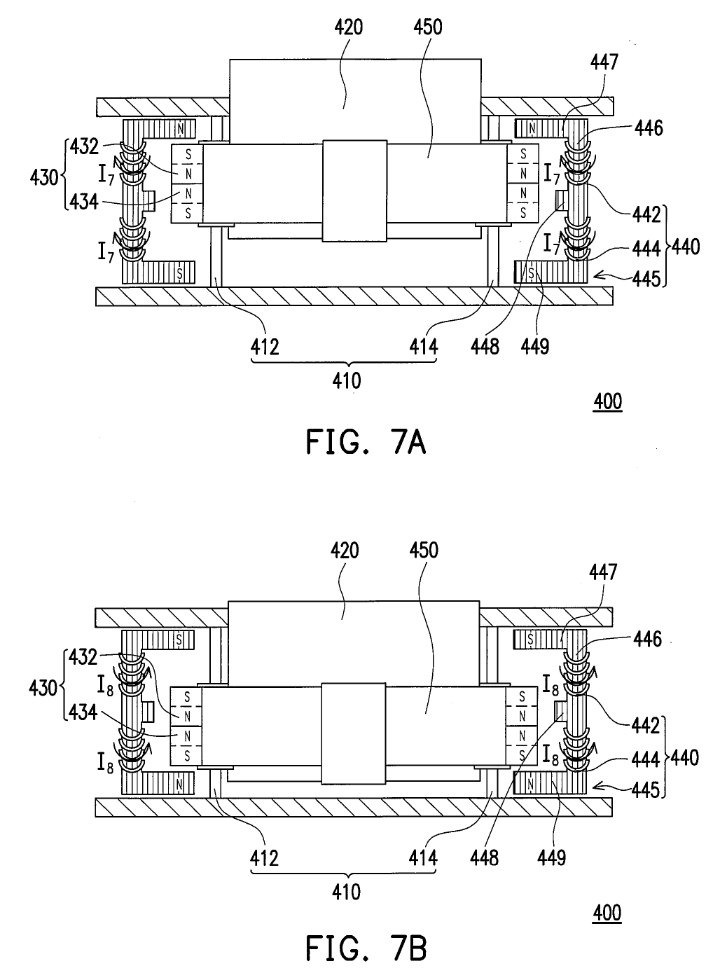

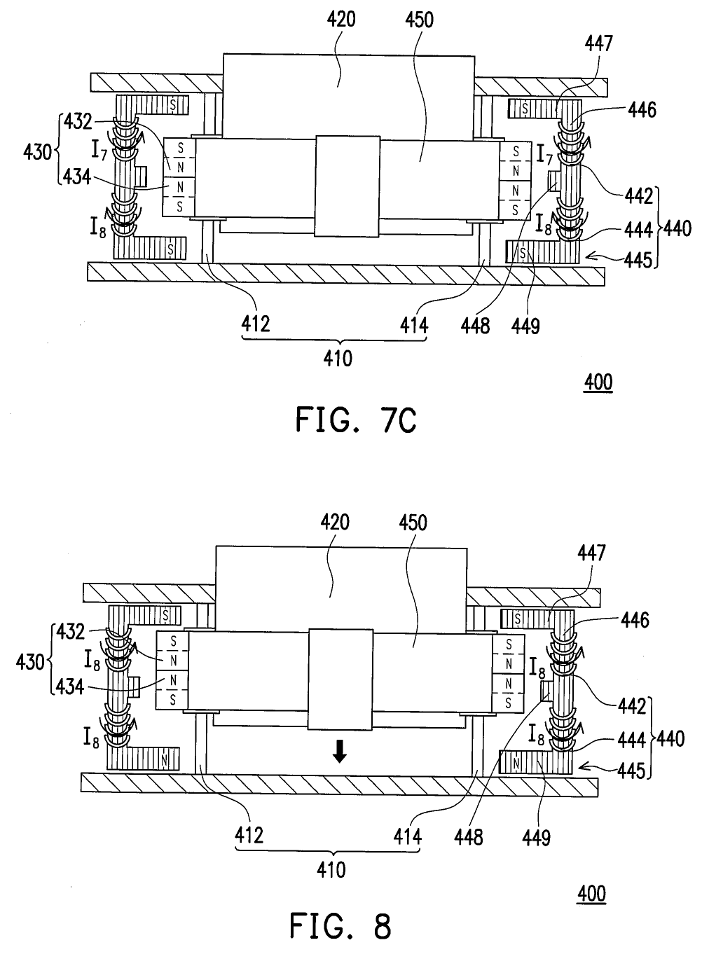

FIGS. 7A to 7C are diagrams showing a lens module at different magnifications according to a third embodiment of the present invention. As shown in FIGS. 7A to 7C, the lens module 400 includes a guide set 410, a lens set 420, a plurality of magnet sets 430 and a plurality of electromagnetic winding sets 440. The lens set 420 is movably disposed on the guide set 410, and the magnet sets 430 are disposed on the lens set 420. The electromagnetic winding sets 440 are disposed on the sides of the lens set 420 and respectively adjacent to one of the magnet sets 430. The electromagnetic winding sets 440 and the magnet sets 430 are suitable for generating electromagnetic forces for controlling the movement of the magnet sets 430. Through the movement of the magnet sets 430, the lens set 420 is driven to move along the guide set 410. In addition, as shown in FIGS. 7A to 7C, the lens module 400 has two magnet sets 430 and two electromagnetic winding sets 440. However, the actual number of magnet sets 430 and the actual number of electromagnetic winding sets 440 used inside the lens module 400 are unrestricted in the present invention.

The foregoing lens module 400 may further include a base 450 connected to the lens set 420, and the magnet sets 430 are disposed on the base 450 so that the magnet sets 430 are connected to the lens set 420 through the base 450. Furthermore, each of the magnetic sets 430 includes two connected magnets 432 and 434 and two poles of each of the magnets 432 and 434 are connected to the base 450, for example. Moreover, the magnetic poles at the junction between two magnets 432 and 434 are identical. In the present embodiment, the magnet poles at the junction between the magnet 432 and the magnet 434 are N-poles, for example, but the magnetic poles can also be S-poles.

Each electromagnetic winding set 440 includes two windings 442, 444 and a ferromagnetic plate 445. The ferromagnetic plate 445 is a silicon steel plate, for example. The ferromagnetic plate 445 includes a linear body 446 and three branches 447, 448, 449 all connected to the linear body 446. The windings 442 and 444 wrap around the linear main body 446 and the branches 447, 448, 449 extend from the two ends of the linear body 446 and between the two windings 442 and 444 on the linear body 446 toward the lens set 420. In addition, the guide set 410 includes a first guide 412 and a second guide 414 substantially parallel to the first guide 412. Moreover, the lens set 420 is disposed on the first guide 412 and the second guide 414.

In the present embodiment, the electromagnetic winding sets 440 and their corresponding magnet sets 430 are suitable for generating electromagnetic forces for controlling the movement of the magnet sets 430. Through the movement of the magnet sets 430, the lens set 420 is driven to move along the guide set 410. In the following, the method of moving the lens set 420 is explained in more detail.

As shown in FIG. 7A, when the lens set 420 needs to be moved to the topmost end of the guide set 410, a current I₇ is passed to the winding 442 and the winding 444 so that the branch 447 is magnetized into an N-pole and the branch 449 is magnetized into an S-pole. Therefore, the attractive force between the branch 447 and the S-pole of the magnet 432 and the repulsive force between the branch 449 and the S-pole of the magnet 434 push the magnet sets 430 up, and drive the base 450 so that the lens set 420 moves along the guide set 410 to the topmost end of the guide set 410. After the lens set 420 has moved to the topmost end of the guide set 410, the supply of current to the windings 442 and 444 is stopped. Because the magnetic property of the magnetized branches 447 and 449 doesn't instantly disappear after the current to the windings 442 and 444 is cut, the position of the lens set 420 is fixed.

As shown in FIG. 7B, when the lens set 420 needs to be moved to the bottommost end of the guide set 410, a current I₈ is passed to the winding 442 and the winding 444 so that the branch 447 is magnetized into an S-pole and the branch 449 is magnetized into an N-pole. Therefore, the repulsive force between the branch 447 and the S-pole of the magnet 432 and the attractive force between the branch 449 and the S-pole of the magnet 434 push the magnet sets 430 down, and drive the base 450 so that the lens set 420 moves along the guide set 410 to the bottommost end of the guide set 410. Similarly, after the lens set 420 has moved to the bottommost end of the guide set 410, the supply of current to the windings 442 and 444 is stopped.

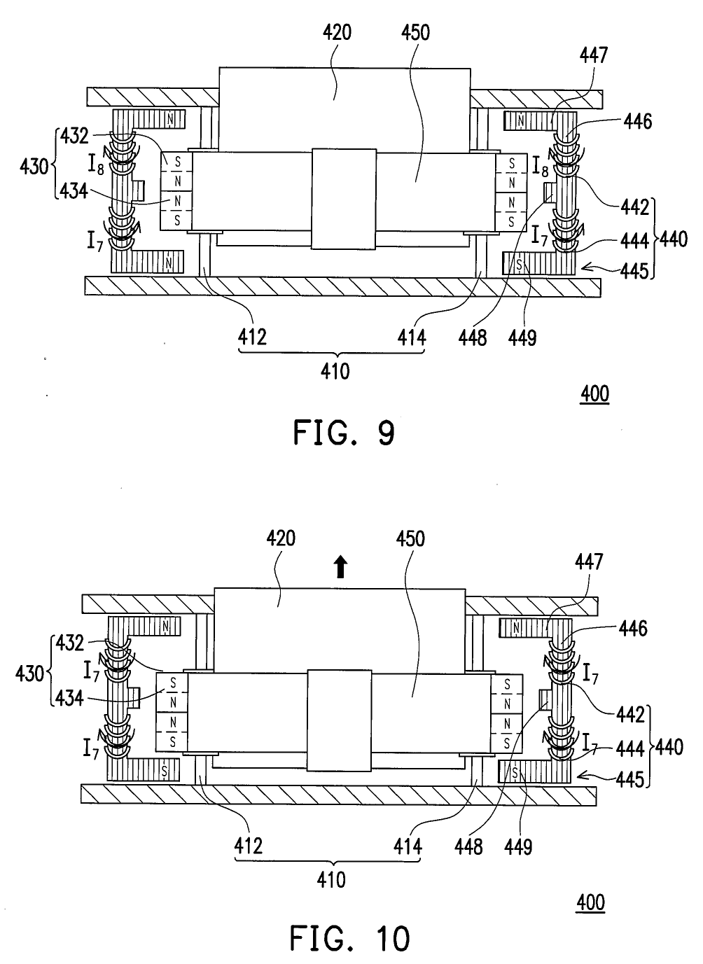

As shown in FIGS. 7C, 8 and 9, when the lens set 420 needs to be moved from the topmost end of the guide set 420 to the middle of the guide set 420, a current I₈ (as shown in FIG. 8) is first passed to the winding 442 and/or the winding 444. Thus, the repulsive force between the branch 447 and the S-pole of the magnet 432 and/or the attractive force between the branch 449 and the S-pole of the magnet 434 push the lens set 420 down. When the lens set 420 has moved to the middle location, the current I₈ is passed to the winding 442 and the current I₇ is passed to the winding 444 (as shown in FIG. 9) so that the lens set 420 is fixed in the middle location of the guide set 410 through the attractive force between the winding 442 and the S-pole of the magnet 432 and between the winding 444 and the S-pole of the magnet 434. Alternatively, when the lens set 420 has moved to the middle location, the current I₇ is passed to the winding 442 and the current I₈ is passed to the winding 444 (as shown in FIG. 7C) so that the lens set 420 is fixed in the middle location of the guide set 410 through the repulsive force between the winding 442 and the S-pole of the magnet 432 and between the winding 444 and the S-pole of the magnet 434. In other words, after the lens set 420 has moved to a middle location of the guide set 410, currents flowing in the opposite direction are passed to the winding 442 and the winding 444 respectively to fix the lens set 420 in the middle location.

On the other hand, when the lens set 420 needs to be moved from the bottommost end of the guide set 420 to the middle location, the current I₇ (as shown in FIG. 10) is first passed to the winding 442 and/or the winding 444 so that the attractive force between the branch 447 and the S-pole of the magnet 432 and/or the repulsive force between the branch 449 and the S-pole of the magnet 434 push the lens set 420 up. Furthermore, when the lens set 420 has moved to the middle location, currents flowing in the opposite direction are passed to the winding 442 and the winding 444 (as shown in FIG. 7C and FIG. 9) so that the lens set 420 is fixed in the middle of the guide set 410 through the attractive force or repulsive force between the winding 442 and the S-pole of the magnet 432 and between the winding 444 and the S-pole of the magnet 434. Similarly, after the lens set 420 has settled in the middle location of the guide set 410, the supply of current to the windings 442 and 444 is stopped.

The magnetic circuit efficiency of the lens module 400 in the present embodiment is high and the starting current is small. Furthermore, because the lens module in the present embodiment has a simple structure, it is less bulky and has a lower production cost. Moreover, the current to the windings 442 and 444 can be cut off immediately when the focusing operation is completed, so as to save power. In addition, the present embodiment is similar to the second embodiment in that the magnitude of the current passing to the windings 442 and 444 is allowed to vary so that the positioning points of the lens set 420 are increased.

In summary, the lens module in the present invention has at least the following advantages:

1. The lens module in the present invention utilizes the control of the direction of current in the electromagnetic winding sets to generate electromagnetic forces between the electromagnetic winding sets and the magnets for moving the magnets and hence the lens set. Since the lens module has a simple structure, it is less bulky and the production cost is lower.

2. By controlling the direction and magnitude of the current in the electromagnetic winding sets, the lens module in the present invention is able to provide a multi-step focusing function.

3. In the second and the third embodiments, the current to the electromagnetic winding sets is immediately cut off after the focusing operation of the lens module is completed. Hence, power is saved.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A lens module, comprising:
a guide set;
a lens set, movably disposed on the guide set;
a magnet connected to the lens set; and
an electromagnetic winding set, disposed on one side of the lens set and adjacent to the magnet, wherein the electromagnetic winding set and the magnet are suitable for generating an electromagnetic force for controlling the movement of the magnet so that the lens set is driven to move along the guide set by the movement of the magnet.

2. The lens module of claim 1, wherein two poles of the magnet are connected to the lens set.

3. The lens module of claim 1, wherein the electromagnetic winding set comprises:
a first electromagnetic winding, disposed at one end of the guide set, wherein the magnet is located on a direction of extension of the first electromagnetic winding; and
a second electromagnetic winding, disposed between two ends of the guide set, wherein a direction of extension of the second electromagnetic winding is different from that of the first electromagnetic winding.

4. The lens module of claim 3, wherein the direction of extension of the second electromagnetic winding is substantially perpendicular to that of the first electromagnetic winding.

5. The lens module of claim 3, wherein each of the first electromagnetic winding and the second electromagnetic winding comprises:
a ferromagnetic plate; and
a winding wrapping around the ferromagnetic plate.

6. The lens module of claim 5, wherein the ferromagnetic plate comprises a silicon steel plate.

7. The lens module of claim 1, wherein the electromagnetic winding set comprises:
two windings;
a ferromagnetic plate, comprising:
a linear body, wherein the windings wrap around the linear body; and
three branches, connected to the linear body and extending from the two ends of the linear body and between the two windings on the linear body toward the lens set.

8. The lens module of claim 7, wherein the branches are substantially perpendicular to the linear body.

9. The lens module of claim 7, wherein the ferromagnetic plate comprises a silicon steel plate.

10. The lens module of claim 1, wherein the guide set comprises:
a first guide; and
a second guide substantially in parallel to the first guide, wherein the lens set is disposed on the first guide and the second guide.

11. A lens module, comprising:
a guide set;
a lens set, movably disposed on the guide set;
a plurality of magnet sets, connected to the lens set; and
a plurality of electromagnetic winding sets, disposed on the sides of the lens set and respectively adjacent to one of the corresponding magnet sets, wherein the electromagnetic winding sets and the magnet sets are suitable for generating electromagnetic forces for controlling the movement of the magnet sets so that the lens set is driven along the guide set by the movement of the magnet set.

12. The lens module of claim 11, wherein each of the magnet sets comprises two connected magnets such that the poles at the junction between the magnets are identical.

13. The lens module of claim 11, wherein the electromagnetic winding set comprises:
two windings;
a ferromagnetic plate, comprising:
a linear body, wherein the windings wrap around the linear body; and
three branches, connected to the linear body and extending from two ends of the linear body and between the two windings on the linear body toward the lens set.

14. The lens module of claim 13, wherein the branches are substantially perpendicular to the linear body.

15. The lens module of claim 13, wherein the ferromagnetic plate comprises a silicon steel plate.

16. The lens module of claim 11, wherein the guide set comprises:
a first guide; and
a second guide substantially in parallel to the first guide, wherein the lens set is disposed on the first guide and the second guide.

17. The lens module of claim 11, further comprising a base connected to the lens set such that the magnet sets are disposed on the base and the magnet sets are connected to the lens set through the base.
